(19) United States
(12) Patent Application Publication
(10) Pub. No.: US 2007/0172130 A1
(43) Pub. Date: Jul. 26, 2007

(54) Structural description of a document, a method of describing the structure of graphical objects and methods of object recognition.

(76) Inventors: Konstantin ZUEV, Moscow (RU); Diar Tuganbaev, Moscow (RU); Irina Filimonova, Moscow (RU)

Correspondence Address: Attn. Sergey Platonov;ABBYY Software Ltd., 11-1, KASATKINA STR., P.O. Box #54, Moscow, 129301, omitted

(21) Appl. No.: 11/461,449

(22) Filed: Aug. 1, 2006

(30) Foreign Application Priority Data
Jan. 25, 2006 (RU) 2006101908 A1

(51) Int. Cl. G06K 9/00; G06K 9/62; G06K 9/54

(52) U.S. Cl. 382/224; 382/305

(57) ABSTRACT

The invention deals with the processing of machine-readable forms of non-fixed format. It comprises the structural description of characteristics of a document elements, a method of describing the logical structure of a document, methods of searching for elements of a document with the use of the structural description. A structural description of the spatial, parametric characteristics of document elements and the logical connections between elements comprises the hierarchical logical structure of the elements, specification of an algorithm of determining the search constraints, specification of every searched element characteristics, specification of the parameters set for a compound element identification on the basis of the aggregate of its components. The method of describing the logical structure of a document and methods of searching for elements of a document are based on the use of the structural description.

The present invention relates generally to image recognition and particularly to the recognition of non-text and/or text objects contained in a bit-mapped image of a document.

The mentioned methods are also applied for, but not limited to, recognition of data input forms, containing typographical and hand-written texts as well as a set of special text-marks for document navigation. Documents as supposed herein are inquiry lists, questionnaires, bank documents with rigid or arbitrary arrangement of data fields.

The mentioned methods may be applied for recognition of predefined form objects contained in an electronic graphical image.

### PRIOR ART

Methods of structure assignment and document element search in an electronic graphical image are known in the art (U.S. Pat. No. 5,416,849 Huang, May 16, 1995).

The capability of the known methods to process only fixed forms, not allowing deviations in field arrangement, is the shortcoming of the methods.

Anyone of the described methods and the system may be taken as a prototype.

The technical result consists in the improvement of searching capabilities as well as the accuracy of identification of obtained image objects, the increase of noise immunity during the process of object search on the image.

### SUMMARY OF THE INVENTION

The declared technical result is achieved by using flexible structural description (assuming the possibility of deviations from the fixed format), tools for assignment, search and identification of objects on an image; with further assignment of the estimate of correspondence of the search result to the description. Numbers from 0 to 1 are used for the evaluation. The accuracy of evaluation is 10⁻⁵. The value equal to 1 means the absolute correspondence of the obtained result to the description. If the estimate differs from zero, the application of flexible structural description also comprises the stage of forming block regions, i.e. calculation of the searched fields allocation on the basis of the information about the found (obtained) objects.

Structural description comprises the description of spatial and parametric characteristics of document elements, the logical connections between document elements and searching methods or algorithms of the elements (fields incl.) of the form.

The method of preliminary assignment of a document structure consists in setting a description of the document's logical structure in the form of interrelation of spatial and parametric characteristics of elements, algorithms of obtaining the parameters of the search for each element, methods of identifying the obtained elements, methods of decreasing the number of obtained variants of an element, acceleration of the search for the best variant.

The method of searching and recognizing the elements (fields or field fragments) of a document on a graphical (bit-mapped) image consists in using of a predefined logical structure of the document in the form of structural description, algorithms of obtaining the parameters of the search for each element, methods of identifying the obtained elements, methods of decreasing the number of obtained variants of an element, acceleration of the search for the best variant.

The essence of the invention with regard to the method of preliminary assignment of a document structure consists in the following. A method of setting the logical structure of a document in the form of a structural description is used which comprises creating a structure of element locations, creating a structure of element connections, and specification of the structure in the form of arrangement and connections of simple and compound elements.

A list and a description of varieties (types) of elements which may be present in the form is preliminarily specified. An algorithm of specifying the search parameters for each element is described in the structural description. A set of at least spatial characteristics of the search area and/or parametric characteristics of the search for each simple and/or compound element is described in the structural description. A set of spatial and parametric characteristics sufficient for search for and identification of an element is used to describe elements of a document of a non-fixed format. A structural description consists of a description of spatial and/or parametric characteristics of the element, and a description of its logical connections with other elements.

A flexible structural description may also additionally include all or some of the following conditions. The logical structure of a document is represented as a sequence of elements connected mainly by hierarchical dependences; an algorithm of determining the search parameters is set, spatial characteristics for searching for each element are specified, parametric characteristics of the searching for each element are set, the set of parameters for identifying a compound element on the basis of the aggregate of components is set, and an algorithm of estimating the quality of an obtained variant of an element is set.

A flexible structural description may also additionally include a separate brief structural description for determining the correct spatial orientation of the image.

A flexible structural description may also additionally include a separate brief structural description for determining the document type and selecting the corresponding comprehensive document description from several possible descriptions. A comprehensive description is created for each document type. If a document type does not have a brief description, then the comprehensive description of the document is used for selecting its type.

The essence of the invention with regard to the method of searching (recognizing) elements (fields) on a document form in a bit-mapped image according to (in accordance with) the first method consists in the following. A method of searching and identifying (including recognition) the elements of a document with non-fixed format comprises at least the following preliminary actions. Revision of the whole document image. Detection of obtained objects or object fragments. Performing an initial classification of detected objects according to the set of predefined types. Recognition of all or a part of text objects, where each object is recognized partially or entirely. To speed up the processing, recognition of text objects is performed to a degree which is sufficient for identifying the document structure and other elements of the form.

A method of search and recognition (identification) of elements (fields) on a document of non-fixed format according to the second variant comprises at least the following preliminary actions. Revision of the entire document image. Allocation of the detected objects or object fragments. Performing the initial classification of the allocated objects according to the set of predefined types. Recognition of all or a part of text objects, where each object is recognized partially or entirely. Recognition of text objects is performed to a degree which is sufficient for identifying the document structure and other elements of the form.

Searching for elements with the help of a flexible structural description is performed sequentially in the order in which they are described in the flexible structural description, top-down through the “tree” (hierarchy) of elements, in accordance with the logical structure of the document description. For each element in the assigned search area, several variants of image objects or sets of image objects corresponding to the description of the element in the structural description may be found. Various obtained variants of objects are considered to be the variants of the position of the element on the image. An estimate of the degree of correspondence of the variant to the element description is assigned to each obtained variant (i.e. the estimate of the quality of the variant).

The accuracy of the obtained position of the object determines the accuracy of obtaining the positions of objects described further in the description relative to this object. Searching for the next dependent object is performed separately for each obtained variant of the current object. Therefore, the variants of objects obtained on the image comprise a hierarchical tree, considerably more branched than the hierarchical tree of elements in a structural description.

If an element or an object is compound, i.e. composed of several parts (simple elements), the whole group also represents an element, which requires generating several possible variants, the number of which corresponds to the number of complete chains of group sub-elements (dependent elements of a lower level). The chain is considered complete if all its obtained sub-elements (elements of a lower level) have sufficient quality. The total estimate of the quality of a variant of a compound element is calculated by multiplying the estimates of the quality of element variants forming the compound element. A flexible structural description as a whole also represents a compound element, therefore, the quality of the correspondence of the variant to the flexible structural description is determined by multiplying the quality factors of its elements.

Application of a flexible structural description comprises searching for the best complete branch in the whole tree of variants, i.e. the branch that include all the elements, from first to last. A general solution of such a task implies taking into consideration all the possible combinations of hypotheses for all elements, construction of a total multitude of complete branches and selecting the best among them. However, in practice, such a solution requires too much calculating resources, and is therefore impractical. Moreover, an abrupt increase in the number of variants taken into consideration is possible, caused by an increase in the number of elements and a lack of rigid restrictions on the search area and element parameters.

To limit the time and resources required to analyze the variants, one of the several methods of decreasing the volume is used.

Each element gets the maximum allowed number of acceptable variants, rated in the quality decreasing order. These variants will be used in the further search, i.e. when searching for the next element. Any variants beyond this number will be discarded. Commonly this number is taken equal to 5 (five) for simple elements and 1 (one) for compound elements. This means that, if 15 variants are obtained for a simple element in the assigned search area, five variants with the best quality rating will be selected. Other 10 chains of variants will not be complete and will not be taken into consideration. A compound element is identified with a greater quality rating than a simple element, because the quality of identification is determined not only by multiplying the quality ratings of the constituent simple elements, but also by several additional (mainly qualitative) characteristics, such as mutual arrangement, object size, correspondence to the conditions of mutual arrangement several elements, and so on.

Since a compound element is identified with a greater quality rating than a simple element, its best variant usually turns out to be accurate.

The process of searching for objects almost always includes generating several incomplete chains of variants of obtained objects and, therefore, several directions of further search. Search for the best hypothesis is performed by using an algorithm of “broad searching”, i.e. the search is always directed through the chain of variants which has the best quality rating at the current step, regardless of the length of the chain. For example, if in a flexible structural description of 30 elements 2 chains are obtained during search, one of which consists of 30 elements with the total quality rating of 0.89 and the other chain has 2 elements with the total quality rating of 0.92, then the second chain will be pursued until its total quality becomes lower than that of the first chain.

The following rule of quality optimization is used for compound elements: if an ideal complete chain for this element is obtained, i.e. the quality of the obtained chain equals 1, other variants of sub-elements composition of this compound element are not taken into consideration.

Moreover, the maximum number of variants for every element in the entire hypothesis tree is restricted to 1000.

### DETAILED DESCRIPTION OF THE INVENTION

The subject of invention with regard to the method of preliminary assignment of a document structure consists in the following. A method of setting the logical structure of a document in the form of a structural description is used which comprises creating a structure of element locations, creating a structure of element connections, and specification of the structure in the form of arrangement and connections of simple and compound elements.

A list and a description of varieties (types) of elements which may be present in the form is preliminarily specified. An algorithm of specifying the search parameters for each element is described in the structural description. A set of at least spatial characteristics of the search area and/or parametric characteristics of the search for each simple and/or compound element is described in the structural description.

A method of identifying the obtained elements, testing the element type, testing the properties typical of the present type, and testing the completeness of the composition of the element is described.

Testing the completeness of the composition of an element comprises estimation of the values of the absolute spatial characteristics of the element, estimation of the values of the relative spatial characteristics of the element, estimation of the values of parametric characteristics of the element, and a rule of assigning quality values to obtained elements and/or parts thereof.

A method or several methods of decreasing the number of analyzed variants of composition of a compound element and accelerating the search for the best variant are described.

Values of spatial and parametric characteristics may be represented as exact and/or interval values.

One or several earlier obtained objects, or any one or several obtained lines, or one or several points, or one or several borders of a document are mainly assigned as the starting point for calculating relative spatial characteristics.

The structure of element connection is mainly realized as a hierarchical structure.

A method of decreasing the number of variants of composition of a compound element comprises the following actions. A limited number of assigned variants with the best quality are kept for further consideration. Other variants are discarded. A search for the best variant of the compound element is performed, taking into account the best total quality of the analyzed components, regardless of their number. The total quality of the compound element is calculated as a product of the quality ratings of the simple and/or compound elements composing it.

The invention with regard to the method of searching (recognizing) elements (fields) on a document form in a bit-mapped image according to (in accordance with) the first method consists in the following. A method of searching and identifying (including recognition) the elements of a document with non-fixed format comprises at least the following preliminary actions. Revision of the whole document image. Detection of obtained objects or object fragments. Performing an initial classification of detected objects according to the set of predefined types. Recognition of all or a part of text objects, where each object is recognized partially or entirely. To speed up the processing, recognition of text objects is performed to a degree which is sufficient for identifying the document structure and other elements of the form.

A separate structural description is set to detect the spatial orientation of an object. Such a description usually contains a brief set of structural elements which can be easily recognized on a document (form). Orientation is accepted as correct if the elements of the structural description coincide with the elements on the image with the best quality estimate (rating).

A corresponding separate brief description is set for quick detection of the type of recognized document and selecting the comprehensive (main) description of the document type from several preliminarily specified descriptions. A comprehensive description is created for each document type. If any document type does not have a brief description, then the comprehensive description of the document is used for selecting its type, and the selection of the document type is performed by comparing the quality estimates of the used (brief or comprehensive) descriptions of different types.

Then the following main actions are performed. Choosing an element for search in the structural description. Obtaining an algorithm of determining the search parameters from the structural description. Searching for the element. Testing the found variants.

Searching for an element comprises the following operations. Search by using the spatial characteristics of the search area (for example, a half-plane, a rectangle, a circle, a polygon, or any combinations thereof). Search by using parametric characteristics of an element. Search by using the spatial characteristics of an element. For example, as absolute coordinates and/or coordinates relative to the other elements (located higher in the tree). The coordinates may be specified as exact values or as an interval.

Search with the help of the preliminary text recognition results.

Testing the detected elements comprises the following actions. Identification of detected elements. Analysis of the results of testing the hypotheses about the presence of the element, completeness of the element composition, and types of composite parts of the element, analysis of correspondence of the structure of a compound element to the hypothesis.

Optimization of the search through element combination variants, further comprises the following actions. Assigning to each element several variants with the best quality rating (estimate), which are kept for further analysis, and discarding all other variants. Searching for the best variant of a compound element, taking into account the best total quality estimate of the composite parts, regardless of their number. The total quality estimate of a compound element is calculated as the product of the quality estimates of the parts thereof. Additionally, other available qualitative characteristics may be taken into consideration.

Initially, the first element in the list is selected.

The following spatial characteristics of an element may be also applied: absolute coordinates and/or coordinates with regard to the other elements.

The coordinates may be specified as exact values or as an interval.

The following spatial characteristics of the search area may be used: half-plane, rectangle, circle, polygon.

Revision of the element combination variants is considered complete if the total quality estimate of the complete set of elements achieves the quality value of 1.

The number of variants of a compound element which have the best quality estimate and are used for further analysis should be in the range from one to three.

The number of variants of a simple element which have the best quality estimate and are used for further analysis should be in the range from three to ten.

A method of search and recognition (identification) of elements (fields) on a document of non-fixed format according to the second variant comprises at least the following preliminary actions. Revision of the entire document image. Allocation of the detected objects or object fragments. Performing the initial classification of the allocated objects according to the set of predefined types. Recognition of all or a part of text objects, where each object is recognized partially or entirely. Recognition of text objects is performed to a degree which is sufficient for identifying the document structure and other elements of the form.

A separate brief structural description may be optionally set to detect the spatial orientation of an object. Such a description usually contains a brief set of structural elements which can be easily recognized on a document (form). Orientation is accepted as correct if the elements of the structural description coincide with the elements on the image with the best quality estimate.

A corresponding separate brief description may be optionally set for quick detection of the type of a recognized document and selecting the comprehensive (main) description of the document type from several preliminarily specified descriptions. A comprehensive description is created for each document type. If any document type does not have a brief description, then the comprehensive description of the document is used for selecting its type, and the selection of the document type is performed by comparing the quality estimates of the used (brief or comprehensive) descriptions of different types.

Then all or at least a part of the following operations are performed.

Choosing the next element in the structural description (starting from the first one).

Calculating or obtaining from the structural description a predefined algorithm for determining the search parameters.

Performing a search for an element, comprising at least the following operations:
searching by using the spatial characteristics of the search area such as, for example, half-plane, rectangle, circle, polygon and others;
searching by using the parametric characteristics of an element (the type of element);
searching by using the spatial characteristics of an element, represented as absolute coordinates and/or coordinates relative to the other elements.

### The coordinates may be specified as exact values or as an interval.

calculating the quality of correspondence of the found variant to the description of the required element.

Testing the obtained variant of the object comprises the following operations:
identifying the obtained element variant;
calculating the quality of the identification of the element;
analyzing the results of testing the hypotheses about the presence and completeness of the composition of the compound element and the types of composite parts, analyzing of the correspondence of a compound element to the hypothesis about the type of the element;
calculating the total quality of the obtained variant.

Optimization of revision of element combination variants comprises
assigning to each type of the element several variants with the best quality rating, which are kept for further analysis;
searching for the best variant of a compound element, taking into account the best total quality estimate of composite parts, regardless of their number;
revision of the quality estimates of the variants which were discarded earlier in order to find any quality estimates higher than the current one.

If the total quality estimate is lower than the predefined level, searching for the next variant of the same element and calculating its total quality estimate are performed.

If the total quality estimate is higher than the predefined level, searching for the next element is performed.

The variant with the maximum total quality estimate is selected.

Searching for the best variant of a compound element is performed, taking into account the best total quality estimate of accountable composite parts, regardless of their number.

The quality of a variant as supposed herein is the estimation which indicates the degree of correspondence of the obtained variant to the present element (its properties and search constraints). The numerical constituent of the quality of a variant is a number ranging from 0 to 1. The quality of a hypothesis for a compound element is calculated by multiplying the quality estimates of the hypotheses of all the sub-elements thereof.

The quality of a variant is a result of multiplication of the quality of the element, assigned at the stage of specification of the structural description during the specification of the element type, and the quality of the element (field, object), calculated at the stage of the search. The total quality of the variant is calculated as a product of quality ratings of all interdependent composing elements in the chain, from the first element in the structural description to the current element.

For optional elements i.e. elements, which may be missing (or not taking into consideration) on a document, a “zero” variant of an element is used, if the element has not been detected. A “zero” variant supposes that the sought object is missing in the search area. A “zero” variant is formed, if no object is detected corresponding to the optional element or the non-“zero” variant quality estimate is lower than the quality of the “zero” variant. If the “zero” variant is selected as the most appropriate, the searching and identifying of the next element in the list in the structural description (including the elements which depend on the not obtained or missing element) is undertaken, or analyzing one of the previously rejected variants of the same or another element, simultaneously taking appropriate steps to avoid obtaining an infinite loop in the process.

If no objects are detected corresponding to the optional element, the use of the flexible description is proceeded (not stopped). Instead of the sought object, a “zero” variant is generated. The “zero” variant gains the quality value of the optional element predefined by the user in the description.

Searching for elements with the help of a flexible structural description is performed sequentially in the order in which they are described in the flexible structural description, top-down through the “tree” (hierarchy) of elements, in accordance with the logical structure of the document description. For each element in the assigned search area, several variants of image objects or sets of image objects corresponding to the description of the element in the structural description may be found. Various obtained variants of objects are considered to be the variants of the position of the element on the image. An estimate of the degree of correspondence of the variant to the element description is assigned to each obtained variant (i.e. the estimate of the quality of the variant).

The accuracy of the obtained position of the object determines the accuracy of obtaining the positions of objects described further in the description relative to this object. Searching for the next dependent object is performed separately for each obtained variant of the current object. Therefore, the variants of objects obtained on the image comprise a hierarchical tree, considerably more branched than the hierarchical tree of elements in a structural description.

If an element or an object is compound, i.e. composed of several parts (simple elements), the whole group also represents an element, which requires generating several possible variants, the number of which corresponds to the number of complete chains of group sub-elements (dependent elements of a lower level). The chain is considered complete if all its obtained sub-elements (elements of a lower level) have sufficient quality. The total estimate of the quality of a variant of a compound element is calculated by multiplying the estimates of the quality of element variants forming the compound element. A flexible structural description as a whole also represents a compound element, therefore, the quality of the correspondence of the variant to the flexible structural description is determined by multiplying the quality factors of its elements.

Application of a flexible structural description comprises searching for the best complete branch in the whole tree of variants, i.e. the branch that include all the elements, from first to last. A general solution of such a task implies taking into consideration all the possible combinations of hypotheses for all elements, construction of a total multitude of complete branches and selecting the best among them. However, in practice, such a solution requires too much calculating resources, and is therefore impractical. Moreover, an abrupt increase in the number of variants taken into consideration is possible, caused by an increase in the number of elements and a lack of rigid restrictions on the search area and element parameters.

To limit the time and resources required to analyze the variants, one of the several methods of decreasing the volume is used.

Each element gets the maximum allowed number of acceptable variants, rated in the quality decreasing order. These variants will be used in the further search, i.e. when searching for the next element. Any variants beyond this number will be discarded. Commonly this number is taken equal to 5 (five) for simple elements and 1 (one) for compound elements. This means that, if 15 variants are obtained for a simple element in the assigned search area, five variants with the best quality rating will be selected. Other 10 chains of variants will not be complete and will not be taken into consideration. A compound element is identified with a greater quality rating than a simple element, because the quality of identification is determined not only by multiplying the quality ratings of the constituent simple elements, but also by several additional (mainly qualitative) characteristics, such as mutual arrangement, object size, correspondence to the conditions of mutual arrangement several elements, and so on.

Since a compound element is identified with a greater quality rating than a simple element, its best variant usually turns out to be accurate.

The process of searching for objects almost always includes generating several incomplete chains of variants of obtained objects and, therefore, several directions of further search. Search for the best hypothesis is performed by using an algorithm of “broad searching”, i.e. the search is always directed through the chain of variants which has the best quality rating at the current step, regardless of the length of the chain. For example, if in a flexible structural description of 30 elements 2 chains are obtained during search, one of which consists of 30 elements with the total quality rating of 0.89 and the other chain has 2 elements with the total quality rating of 0.92, then the second chain will be pursued until its total quality becomes lower than that of the first chain.

The following rule of quality optimization is used for compound elements: if an ideal complete chain for this element is obtained, i.e. the quality of the obtained chain equals 1, other variants of sub-elements composition of this compound element are not taken into consideration.

Moreover, the maximum number of variants for every element in the entire hypothesis tree is restricted to 1000.

For the flexible structural description creation the following main types of elements is used conventionally divided into the following: Simple elements and Compound elements.

Simple element not containing other elements: Static Text, Separator, White field, Barcode, Text String, Text Fragment, Set of objects, Date, Phone Number, Currency, and Table, and compound elements—Group, and some other types.

Compound element (element group), as supposed herein, is an aggregate of several elements (sub-elements). Sub-elements may be simple or compound.

Static text, as supposed herein, is an element of structural description describing a text with the known meaning. The text may consist of one word, of several words, or of an entire paragraph. “Several words” differs from “a word” by the presence of at least one blank space or another inter-word separator, depending on the language, for example, a full stop, a comma, a colon, or any other punctuation mark. Several words may take up several text strings.

Separator, as supposed herein, is an element representing a vertical or horizontal graphical object between other objects. A separator can be represented, for example, by a solid line or a dotted line.

White field, as supposed herein, is an element of description representing a rectangular region of an image which does not contain any objects within it.

Barcode, as supposed herein, is an element of flexible description representing a line drawing which codes numerical information.

Text string, as supposed herein, is an element representing a sequence of characters located on a single line one after another. Character strings can consist of text objects, for example, words, or of fragments of text objects.

Text fragment, as supposed herein, is an element representing an aggregate of text objects.

Set of objects (of the specified type), as supposed herein, is an element representing an aggregate of different types of objects on an image, where each object meets the search constraints.

Date as supposed herein, is an element representing a date.

Telephone number, as supposed herein, is an element representing a telephone number which may be accompanied a by prefix (“tel.”, “home tel.”, etc.) and by a code of the city/region, which is separated from the number by brackets.

Currency, as supposed herein, is an element of description representing money sums, where the name of the currency can be used as the prefix.

Table, as supposed herein, is an element of flexible description representing data in the form of a table.

Compound elements are used for:
joining elements into a group. Each of these compound elements may contain smaller compound elements meant for smaller fragments of the element search;
providing the logical hierarchy of elements for better navigation through the structural description;
reducing the number of possible variants of the element in order to speed up the search for the resulting variant. Joining elements into a compound element allows to analyze this set of sub-elements as a single entity which has its own complete variant (consisting of the variants of the sub-elements) and a total estimate of reliability of the entire group. Revision of possible combinations of variants of the sub-elements is performed within the group, and only a predefined number of the best variants in the group take part in the further analysis and search for the next elements. The number of the best variants of a compound element which take part in further searching is usually 1;
specifying restrictions of the search area which are common for all the sub-elements. The search area of a certain sub-element in this case is calculated as the intersection of the search area set for the sub-element itself and the search area of the group which contains this sub-element.

Any particular method or procedure mentioned and not described in details herein is presumed to be not part of the invention itself. Those particular methods or procedures are presumed to be known and described in details in the art. To realize the methods and devices of the present invention any of the particular methods and devices known in the art can be used, however, with the different efficiency.

We claim:

1. A structural description of the spatial, parametric characteristics of an element and logical connections thereof with other elements of a non-fixed layout document, comprising
an assigned description of logical connections with other elements,
an assigned description of spatial characteristics of the element,
an assigned description of parametric characteristics of the element,
an assigned algorithm of determining the elements search constraints,
an assigned set of parameters for identification of a compound element on the basis of the aggregate of constituents,
said description of logical connections are represented as a hierarchical sequence of elements;
said description of spatial characteristics fit for searching for each element;
said description of parametric characteristics fit for searching for each element.

2. The structural description, as recited in claim 1, further comprising the setting of algorithm of estimating the quality of an obtained variant of an element.

3. The structural description, as recited in claim 2, wherein the algorithm of estimating the quality of an obtained variant of an element is set in the form of a reference table.

4. The structural description, as recited in claim 2, wherein the algorithm of estimating the quality of an obtained variant of an element is set in the form of a graph or formula.

5. The structural description, as recited in claim 1, further optionally comprise specification of an auxiliary brief description for determination of the spatial orientation of the image.

6. The structural description, as recited in claim 1, further optionally comprise specification of an auxiliary brief description to quickly select the type of the document and/or its comprehensive description from several preliminary specified thereof.

7. A method of specifying the logical structure of the document, comprising:
preliminarily specification of the list and description of all varieties of the elements which may be present on the form;
creation of the structure of the elements logical connections;
creation of the structure of the elements disposition;
assignment of the structure as the disposition of simple and compound elements;
assignment of the structure representation as the interrelations between simple and compound elements;
assignment of the algorithm of specifying the search constraints of each element;
specification of the set of at least the following characteristics for each simple and compound element search:
the spatial characteristics of the search area;
the parametric characteristics of the element,
description of methods of the obtained elements identification, determination of the type of the element, determination of the distinctive properties of the each element type, and testing the completeness of the composition of parts of the compound element, said methods using the following information:
values of the absolute spatial characteristics of the element and/or
values of the relative spatial characteristics of the element;
values of the parametric characteristics of the element;
a rule of assigning quality ratings to obtained elements,
description of a method of decreasing the number of variants of a compound element composition, and a method of accelerating the search for the best variant thereof.

8. The method of specifying the logical structure of a document, as recited in claim 7, wherein the spatial characteristics of an element are included in the set of search characteristics thereof.

9. The method of specifying the logical structure of a document, as recited in claim 7, wherein the spatial and parametric characteristics are represented as exact values.

10. The method of specifying the logical structure of a document, as recited in claim 7, wherein the spatial and parametric characteristics are represented as intervals of values.

11. The method of specifying the logical structure of a document, as recited in claim 7, wherein one or several earlier obtained objects, or one or several obtained lines, or one or several points, or one or several borders of the document are assigned as the reference points for the relative spatial characteristics.

12. The method of specifying the logical structure of a document, as recited in claim 7, wherein the hierarchical structure of connections between the elements is set.

13. The method of specifying the logical structure of a document, as recited in claim 7, wherein the method of decreasing the number of variants of the composition of a compound element and accelerating the search process further comprises:
assigning a number of variants with the best quality estimates which will be kept for further analysis to each type of the element;
performing a search for the best variant of a compound element, taking into account the best total quality of its accountable composite parts, regardless of their number.

14. A method of searching for elements of form with the use of structural description, comprising at least the following steps:
obtaining the structural description of the form;
searching for objects on the image;
allocating the obtained objects;
revealing the text objects, to be mandatory recognized, and determining the minimal required scope of recognition;
performing recognition of said text objects;
performing the search for elements of the form, comprising at least the following steps:
selecting a searched element in the structural description;
gaining the algorithm of obtaining the search constraints from the structural description;
performing the search of the element on the form image;
examining of the obtained variants;
optimizing the variants revision of the compound element components combinations,
said search for an element comprises with the use of the following characteristics:
spatial characteristics of the search area;
parametric characteristics of the element;
absolute and/or relative spatial characteristics of the element represented as exact values and/or as intervals of values;
results of preliminary text recognition,
said examination of the obtained variants of elements comprises the following steps:
identifying the obtained variant of the element;
estimating the quality of the identification of the element;
analyzing the results of testing the hypotheses about the presence, completeness of composition, and types of composite parts, analyzing their correspondence to the hypothesis about the type in the case of a compound element;
estimating the total reliability of the obtained variant,
said optimizing the variants revision of the compound element components combinations, comprising:
assigning a number of variants with the best quality ratings which will be kept for further analysis to each type of the element;
discarding the other variants;
searching for the best variant of the compound element, taking into account the best total quality of its accountable composite parts, regardless of their number;
analyzing the quality estimates of earlier rejected variants in order to find quality estimates higher then the current best variant estimate.

15. A method of searching for an element of the form of non-fixed layout using structural description, comprising at least the following steps (operations):
searching for the object on the image;
allocation of the found objects;
determining types of the found objects;
revealing the text objects, to be mandatory recognized, and determining the minimal required scope of recognition;
recognizing said text objects;
performing search for elements of the form comprising at least the following steps:
selecting a searched element in the structural description;
gaining the algorithm of obtaining the search constraints;
searching for the element on the form image;
examining of the obtained variants;
optimizing the variants revision of the compound element components combinations,
said searching for an element comprises the use of the following characteristics:
the spatial characteristics of the search area;
the parametric characteristics of the element;
the spatial characteristics of the element,
said examining of the obtained variants comprises the following actions:
identifying the obtained elements;
analyzing the results of testing the hypotheses about the presence and completeness of composition of the elements, and the types of the composite parts, analyzing the correspondence to the hypothesis about the composition of the compound element,
said optimizing the variants revision of the compound element components combinations comprising:
assigning a number of variants with the best quality ratings which will be kept for further analysis to each type of the element;
searching for the best variant of the compound element, taking into account the best total quality of its accountable composite parts, regardless of their number,
analyzing the quality estimates of earlier rejected variants in order to find quality estimates higher than the current estimate.

16. The method of searching, as recited in claim 14 or 15, wherein the orientation of the image is determined.

17. The method of searching, as recited in claim 16, wherein all or a part of elements of the structural description are used to determine the correct image orientation.

18. The method of searching, as recited in claim 16, wherein an auxiliary brief description is optionally specified to determine the spatial orientation of the image.

19. The method of searching, as recited in claim 16, wherein the image orientation resulting objects coincidence with the description thereof with the highest quality rating is accepted as the correct one.

20. The method of searching, as recited in claim 14 or 15, wherein the type of a document is selected from several preliminary specified types.

21. The method of searching, as recited in claim 20, wherein a supplementary brief structural description is optionally assigned for determining the document type and thus selecting the corresponding comprehensive document description from several preliminarily specified thereof.

22. The method of searching, as recited in claim 21, wherein the type of the document which corresponds to the current image is selected on the basis of comparing the quality estimates of the coincidence with the preliminarily specified candidate descriptions.

23. The method of searching, as recited in claims 14 or 15, wherein initially the first element in the list is selected.

24. The method of searching, as recited in claims 14 or 15, wherein the applied spatial characteristics of an element comprises at least its absolute coordinates and/or relative coordinates.

25. The method of searching, as recited in claims 14 or 15, wherein the exact and/or interval characteristics of an element are used.

26. The method of searching, as recited in claims 14 or 15, wherein at least the following spatial characteristics of the search area are used: a half plane, a rectangle, a circle, a polygon, or a combination thereof.

27. The method of searching, as recited in claims 14 or 15, wherein revision of variants of combinations of the elements is considered complete if the total quality estimate of the complete set of elements achieves the quality value of 1.

28. The method of searching, as recited in claims 14 or 15, wherein one to three variants of a compound element which have the best quality estimate are used for further analysis.

29. The method of searching, as recited in claims 14 or 15, wherein three to ten variants of a simple element which have the best quality estimate are used for further analysis.

30. The method of searching, as recited in claims 14 or 15, wherein searching for the next element is performed if no variants for the current element found or the total quality rating is lower than the predefined level.

31. The method of searching, as recited in claims 14 or 15, wherein if no objects are found in the region of the image which is specified therefore a further search is undertaken for an object corresponding to the next element of the structural description.
